(19) United States
(12) Patent Application Publication
(10) Pub. No.: US 2019/0065583 A1
(43) Pub. Date: Feb. 28, 2019

(54) COMPOUND Q&A SYSTEM

(71) Applicant: INTERNATIONAL BUSINESS MACHINES CORPORATION, ARMONK, NY (US)

(72) Inventors: Brendan C. Bull, Durham, NC (US); Scott R. Carrier, Apex, NC (US); Aysu Ezen Can, Cary, NC (US); Dwi Sianto Mansjur, Cary, NC (US)

(21) Appl. No.: 15/687,871

(22) Filed: Aug. 28, 2017

(51) Int. Cl. G06F 17/30

(52) U.S. Cl. CPC G06F 17/30684; G06F 17/30696; G06F 17/30663

(57) ABSTRACT

Embodiments of the present invention disclose a method, a computer program product, and a computer system for answering compound questions. A computer receives a compound question and identifies one or more sub questions. The computer identifies natural language processing features of the compound questions and generates a logical representation of the compound question. The computer retrieves and ranks candidate answers to the one or more sub questions and evaluates them in the context of other sub questions, then provides final answers to the one or more sub questions.

### BACKGROUND

The present invention relates generally to natural language processing, and more particularly to answering compound questions by breaking them down into sub questions in question and answer (Q&A) systems. The following exemplary embodiments provide a system, method, and program product to, among other things, improve the answering of compound questions by a computing system. Therefore, the present embodiment has the capacity to improve the technical field of Q&A systems by answering sub questions of a compound question in the context of other sub questions, thereby increasing the accuracy of the returned answers.

Q&A systems have difficulty in answering compound questions with multiple qualifiers, for example negation, multiple clauses, relevance, and conditionality. The intent of compound questions can be difficult to discern and adequately deciphering the question is key to delivering relevant answers. Traditional Q&A systems tend to assume there is one answer to compound questions with these issues, however compound questions have sub questions within a larger question that need to be answered independently.

### SUMMARY

Embodiments of the present invention disclose a method, a computer program product, and a computer system for answering compound questions. A computer receives a compound question and identifies one or more sub questions. The computer identifies natural language processing features of the compound questions and generates a logical representation of the compound question. The computer retrieves and ranks candidate answers to the one or more sub questions and evaluates them in the context of other sub questions, then provides final answers to the one or more sub questions.

In some embodiments, the computer may receive a compound question comprising one or more sub questions and generate a logical parse of the compound question using a logical reasoning system. Moreover, the computer may identify sub questions using a syntax parse. In this embodiment, the computer answers the compound question based on the syntax parse and logical parse.

In some illustrative embodiments, the computer determines whether an instance of a term appears in two or more sub questions, or subtrees, of the logical parse and, based on determining that an instance of a term appears in two or more subtrees, identifying one or more candidate answers that answer the two or more subtree questions.

In further embodiments, the computer identifies one or more candidate answers that answer at least one of the two or more subtree questions based on determining that an instance of a term does not appear in two or more subtrees of the compound question.

In some embodiments, the computer ranks and displays the one or more candidate answers.

In yet further embodiments, the computer answers the compound question based on identifying a negated span of text, a hypothetical span of text, or a relevance qualified span of text within the compound question.

In these further embodiments, the computer may determine whether the negated span of text contains a linking verb and, based on determining that the negated span of text contains a linking verb, excluding one or more candidate answers meeting a criteria within the negated span of text. Alternatively, based on the computer determining that the negated span of text does not contain a linking verb, the computer excluding one or more candidate answers detailed by the negated span of text.

### BRIEF DESCRIPTION OF THE SEVERAL VIEWS OF THE DRAWINGS

FIG. 1 is a schematic diagram of an compound Q&A system 100, in accordance with an embodiment of the present invention.

FIG. 2 is a flowchart illustrating the operation of Compound Q&A program 132 of Q&A system 100 in answering a compound questions, in accordance with an embodiment of the present invention.

FIG. 3 depicts a sub question with annotated relevance qualifiers, in accordance with an embodiment of the present invention.

FIG. 4 depicts a syntax parse of a compound question into sub questions, in accordance with an embodiment of the present invention.

FIG. 5 depicts a logical parse of a compound question, in accordance with an embodiment of the present invention.

FIG. 6 depicts a logical parse of a compound question with semantic entanglement, in accordance with an embodiment of the present invention.

FIG. 7 depicts a full logical rollup of logical structure for a compound question, in accordance with an embodiment of the present invention.

FIG. 8 depicts a full logical rollup of a logical structure for a compound question, in accordance with an embodiment of the present invention.

FIG. 9 depicts the displaying of candidate answers, in accordance with an embodiment of the present invention.

FIG. 10 is a block diagram depicting the hardware components of an entity relation extraction system 100 of FIG. 1, in accordance with an embodiment of the invention.

FIG. 11 depicts a cloud computing environment, in accordance with an embodiment of the present invention.

FIG. 12 depicts abstraction model layers, in accordance with an embodiment of the present invention.

### DETAILED DESCRIPTION

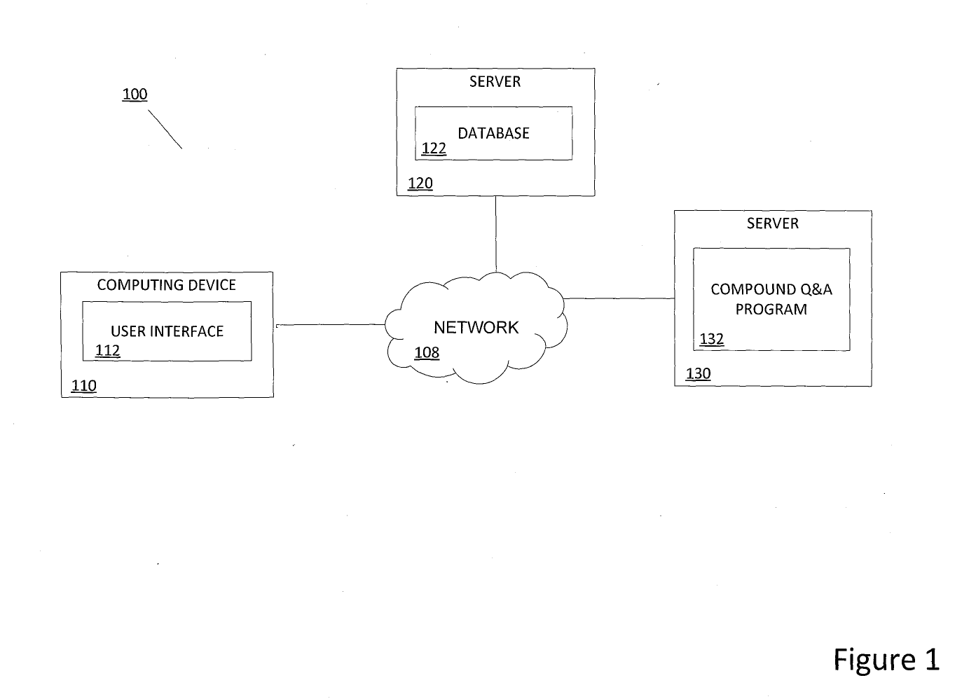

A compound Q&A system 100 in accordance with an embodiment of the invention is illustrated by FIG. 1.

In the example embodiment, network 108 is a communication channel capable of transferring data between connected devices. In the example embodiment, network 108 may be the Internet, representing a worldwide collection of networks and gateways to support communications between devices connected to the Internet. In this embodiment, network 108 may include, for example, wired, wireless, or fiber optic connections which may be implemented as an intranet network, a local area network (LAN), a wide area network (WAN), or any combination thereof. In further embodiments, network 108 may be a Bluetooth network, a WiFi network, or a combination thereof. In yet further embodiments, network 108 may be a telecommunications network used to facilitate telephone calls between two or more parties comprising a landline network, a wireless network, a closed network, a satellite network, or any combination thereof. In general, network 108 can be any combination of connections and protocols that will support communications between computing device 110, server 120, and server 130.

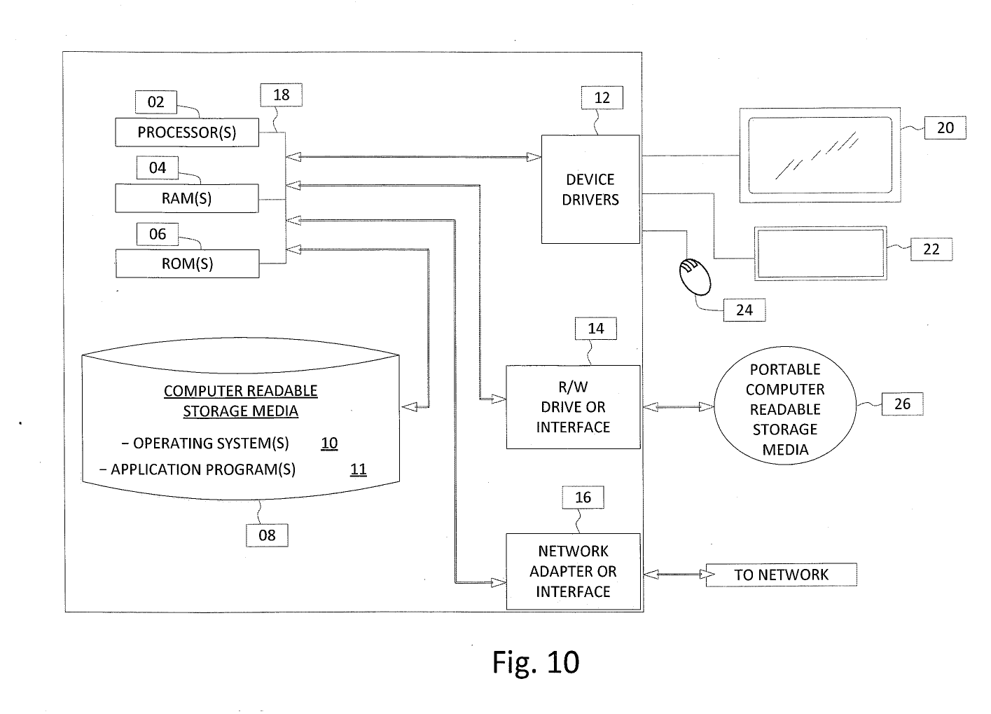

In the example embodiment, computing device 110 includes user interface 112. Computing device 110 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While computing device 110 is shown as a single device, in other embodiments, computing device 110 may be comprised of a cluster or plurality of computing devices, working together or working separately. Computing device 110 is described in more detail with reference to FIG. 10.

User interface 112 is a software application that allows a user of computing device 110 to interact with computing device 110 as well as other connected devices via network 108. In addition, user interface 112 may be connectively coupled to hardware components, such as those depicted by FIG. 10, for receiving user input, including mice, keyboards, touchscreens, microphones, cameras, and the like. In the example embodiment, user interface 112 is implemented via a web browsing application containing a graphical user interface (GUI) and display that is capable of transferring data files, folders, audio, video, hyperlinks, compressed data, and other forms of data transfer individually or in bulk. In other embodiments, user interface 112 may be implemented via other integrated software applications, standalone software applications, or hardware capable of receiving user interaction and communicating with other electronic devices.

In the example embodiment, server 120 includes database 122. Server 120 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While server 120 is shown as a single device, in other embodiments, server 120 may be comprised of a cluster or plurality of computing devices, working together or working separately. Server 120 is described in more detail with reference to FIG. 10.

Database 122 is a collection of information contained in files, folders, and other documents. In the example embodiment, database 122 may be a corpora of documents which detail bodies of categorized and subject specific data, such as medical, legal, and financial data. In other embodiments, database 122 may include uncategorized data of miscellaneous topics. In the example embodiment, database 122 may be structured (i.e. have associated metadata), partially structured, or unstructured. Moreover, data within database 122 may be written in programming languages of common file formats such as .docx, .doc, .pdf, .rtf, etc. In other embodiments, database 122 may include handwritten and other documents scanned or otherwise converted into electronic form.

In the example embodiment, server 130 includes compound Q&A program 132. Server 130 may be a laptop computer, a notebook, a tablet computer, a netbook computer, a personal computer (PC), a desktop computer, a personal digital assistant (PDA), a rotary phone, a touchtone phone, a smart phone, a mobile phone, a virtual device, a thin client, or any other electronic device or computing system capable of receiving and sending data to and from other computing devices. While server 130 is shown as a single device, in other embodiments, server 130 may be comprised of a cluster or plurality of computing devices, working together or working separately. Server 130 is described in more detail with reference to FIG. 10.

In the example embodiment, compound Q&A program 132 is a software application capable of receiving a compound question and providing one or more answers to the received compound question. More specifically, compound Q&A program 132 is capable of identifying sub questions of the compound question and identifying natural language features of the sub questions. Moreover, compound Q&A program 132 is further capable of constructing a logical representation of the sub questions and refining an understanding of the sub questions relations. In addition, compound Q&A program 132 is capable of identifying relevance qualifiers within the sub questions and retrieving candidate answers to the sub questions. Lastly, compound Q&A program 132 is capable of performing a final rollup of the candidates to the sub questions and presenting the best answers.

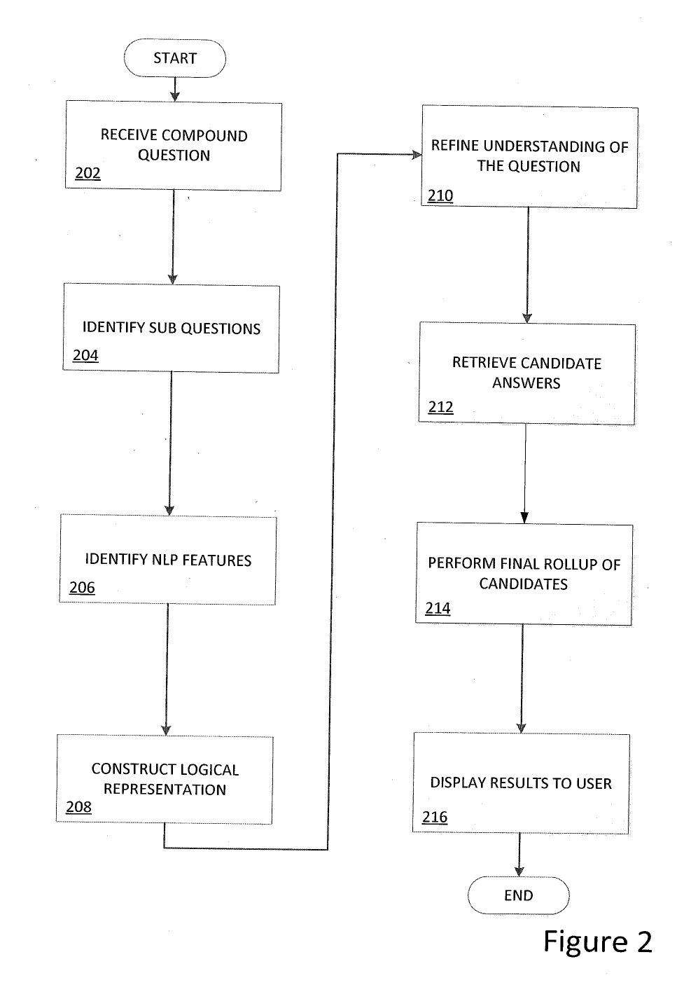

FIG. 2 depicts a flowchart illustrating the operations of compound Q&A program 132, in accordance with an embodiment of the present invention. In the example embodiment, compound Q&A program 132 breaks down compound questions into sub questions that are individually answered and rolled up together logically to answer the full compound question.

Compound Q&A program 132 receives a compound question (step 202). In the example embodiment, compound Q&A program 132 receives a compound question from computing device 110 via user interface 112 and network 108 in the form of natural language, for example written or spoken human language. The compound question may comprise multiple sub questions which may contain qualifiers, such as negated spans, hypothetical spans, and relevance qualified spans. In other embodiments, compound Q&A program 132 may receive structured questions, for example questions written in structured query language (SQL). Moreover, in these other embodiments, compound Q&A program 132 may receive a compound question alternatively or retrieve the compound question from a specified location.

With reference now to an illustrative example, compound Q&A program 132 receives the four compound questions: (1) Show the metastatic sites but not local sites and sites that aren't positive for metastasis but are concerning; (2) Show me sites that may be metastatic; (3) Show the metastatic sites that have been present for more than 1 month and confirmed by x-ray; and (4) Show the metastatic sites, not local sites, does not necessarily have to be positive for metastasis.

Compound Q&A program 132 identifies sub questions of the received compound question (step 204). In the example embodiment, compound Q&A program 132 identifies sub questions of the compound question using a syntax parse to identify conjunctive locations. A syntax parse is a technique in linguistic analysis used to identify constituents of a sentence or string of words. The analysis outputs a parse tree showing the constituents syntactic and semantic relation to each other wherein each subtree of the parse tree roughly represents a sub question. In the example embodiment, compound Q&A program 132 utilizes a syntax parse to identify conjunction locations that include parts of speech such as nouns, verbs, adverbs, prepositions, adverbs, determiners, etc., and natural language connectives such as but, except, and, or, and the like. Compound Q&A program 132 considers each identified conjunctive location as a boundary between individual sub questions within the compound question. While in the example embodiment compound Q&A program 132 utilizes a parse tree to identify sub questions, compound Q&A program 132 may identify sub questions in other embodiments alternatively.

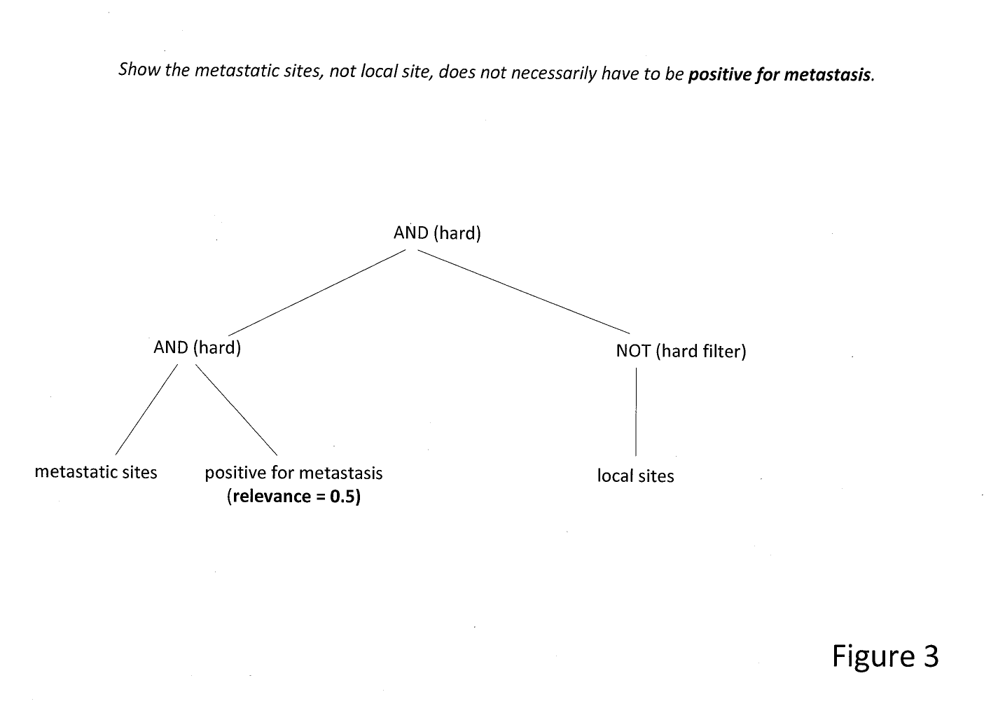

With reference now to the first example introduced earlier having the question Show the metastatic sites but not local sites and sites that aren't positive for metastasis but are concerning, compound Q&A program 132 utilizes a syntax parse to generate a syntax parse tree, depicted by FIG. 3, identifying conjunctive locations within the compound question. More specifically, compound Q&A program 132 identifies conjunction locations at the logical connectives but (conjunctions 301 and 303) and and (conjunction 303). Based on the identified conjunctive locations, compound Q&A program 132 breaks down the compound question into three distinct sub questions to be answered individually: metastatic sites but not local sites, sites that aren't positive for metastasis but are concerning, and the conjunction of 1 and 2.

With reference again to FIG. 2, compound Q&A program 132 identifies natural language processing (NLP) features within the compound question (step 206). In the example embodiment, compound Q&A program 132 identifies natural language processing (NLP) features to better understand a meaning of the identified sub questions. Common NLP features or qualifiers that may alter a meaning of a sub question include, for example, negation, hypothetical language, and relevance. In the example embodiment, compound Q&A program 132 utilizes NLP methods to detect special qualifiers within the question, such as negation detection techniques to identify negated spans. Moreover, compound Q&A program 132 is capable of further determining whether identified negations apply a hard filter, i.e. return none of these answers, vs. a soft filter, i.e. return answers that exhibit this particular property. In the example embodiment, compound Q&A program 132 distinguishes hard filters from soft filters by keyword searching for keywords indicative of possession or exhibition of a particular characteristic. Such keywords may include linking verbs, copula, and state of being verbs such as be, is, are, am, having, be, being, been, and the like. If compound Q&A program 132 determines that a negated span contains one of the aforementioned keywords, compound Q&A program 132 identifies the negated span as a having soft filter, i.e. return answers having this property. Alternatively, if compound Q&A program 132 does not identify any of the aforementioned keywords in a negated span, compound Q&A program 132 identifies the negated span as having a hard filter, i.e. do not return any of these answers.

Continuing the earlier introduced first example having the question Show the metastatic sites but not local sites and sites that aren't positive for metastasis but are concerning, compound Q&A program 132 utilizes negation detection to identify two negated spans within the compound question: not local sites and aren't positive for metastasis. Based on compound Q&A program 132 failing to identify a possessive keyword (is, are, am, etc.) within the negated span not local sites, compound Q&A program 132 determines that the span contains a hard filter on the negated span and, more specifically, should treat the sub question as excluding local sites entirely. Conversely, based on compound Q&A program 132 determining that the negated span aren't positive for metastasis has a be verb anchoring the clause (aren't), compound Q&A program 132 determines that the span contains a soft filter and, more specifically, is seeking sites that do not test positive for metastasis.

In addition, compound Q&A program 132 further detects hypothetical language within a compound question using NLP hypothetical detection techniques (step 206 continued). With reference now to the second example question Show me sites that may be metastatic, compound Q&A program 132 utilizes hypothetical detection to determine that the question contains the keyword may as indicative of a hypothetical span and, more specifically, is seeking sites that aren't confirmed to be metastatic.

Compound Q&A program 132 identifies relevance qualifiers within the compound question (step 206 continued). In the example embodiment, compound Q&A program 132 utilizes NLP feature detection to identify relevance qualifiers within the compound question and uses the relevance qualifiers as an indication of question and answer priority. Specifically, compound Q&A program 132 prioritizes answers which meet the more relevant criteria than answers meeting less relevant criteria when ranking the candidate answers. For each relevance qualifier found in the compound question, compound Q&A program 132 annotates the relevance qualified criteria, or span, with a relevance score. Relevance scores indicate which criteria is prioritized when searching for answers to a compound question or sub question. By default, a relevance score of one is assigned to all criteria within the compound question, from which relevance may be increased or decreased. In the example embodiment, compound Q&A program 132 searches for answers meeting all criteria, both more and less relevant, and takes the relevance score into account when ranking the candidate answers meeting said criteria (described in greater detail below). Specifically, candidate answers meeting higher relevance criteria will be ranked higher than candidate answers meeting lower relevance criteria.

Continuing an example using the fourth example question Show the metastatic sites, not local sites, does not necessarily have to be positive for metastasis, compound Q&A program 132 identifies the clause not necessarily as a relevance qualifier for the criteria positive for metastasis, indicating that the user wants to prioritize metastatic sites over sites that are borderline and not yet confirmed as metastatic. Accordingly, compound Q&A program 132 annotates the criteria positive for metastasis as being less important by assigning a relevance score of 0.5 to the criteria (as opposed to 1.0 default relevance). The relevance score of this particular example is depicted visually by FIG. 3.

Compound Q&A program 132 constructs a logical representation of the compound question in order to understand the broad logical linkage between the sub questions (step 208). In the example embodiment, compound Q&A program 132 constructs a logical parse using an NLP method, such as a Logical Reasoning System (LRS). A LRS generates a hierarchical representation of logical relationships within natural language content (or textual content) and models the semantic relations of the natural language content in the form of leaf nodes, logical nodes, intermediate nodes, and root nodes. From the logical parse, compound Q&A program 132 arranges the sub questions and identifies semantic entanglement between the sub questions and subtrees of the logical parse. Semantic entanglement occurs when the subtrees are related, for example when one sub question is a follow-up to another sub question, or when a sub questions need be interpreted differently based on the surrounding context of other sub questions and/or the compound question. In the example embodiment, compound Q&A program 132 considers two or more terms entangled when the same instance of a term, as identified by the LRS, can be found in multiple subtrees and/or sub questions. In other embodiments, compound Q&A program 132 may identify semantic entanglement otherwise.

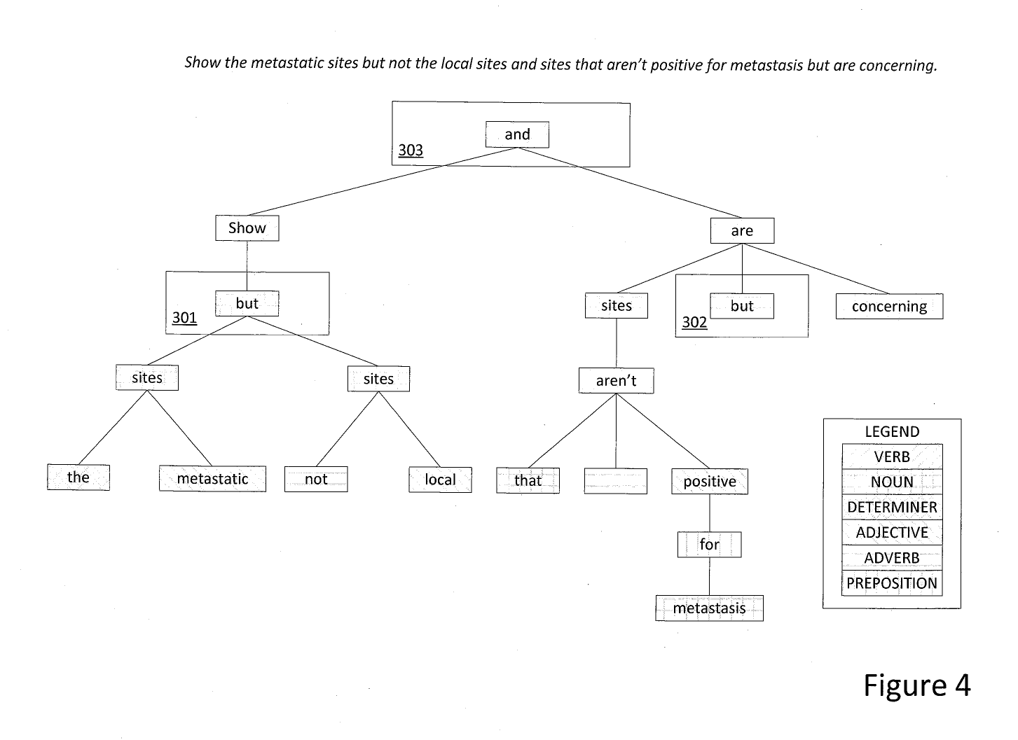

Continuing with the first example question Show the metastatic sites but not local sites and sites that aren't positive for metastasis but are concerning, compound Q&A program 132 utilizes an LRS to construct a logical parse of the compound question, as depicted by FIG. 4. Based on the logical parse, compound Q&A program 132 determines that there is no semantic entanglement because there are no instances of a term which appear in more than one of the subtrees. Note that the logical parse groups the sub questions similar to that of the syntax parse.

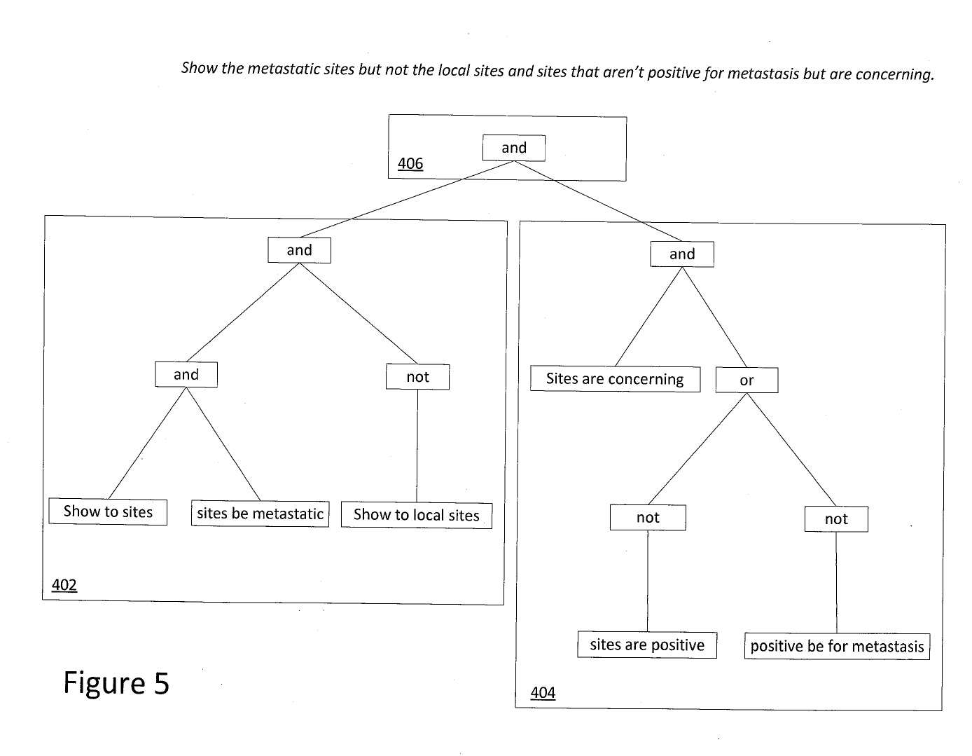

Conversely, and with reference now to the third example question Show the metastatic sites that have been present for more than 1 month and confirmed by x-ray, compound Q&A program 132 constructs a logical representation, as depicted by FIG. 5, to determine that there is semantic entailment between the terms sites 504 and x-ray 506 because the same instance of the terms appear in both sub questions, i.e. subtree branches. In the case of the term sites 504, it has relationships with the terms confirmed and metastatic with a common parent of the root and 502, indicating that the term sites 504 is entangled. Note in this case that because there is semantic entanglement, compound Q&A program 132 is incapable of cleanly grouping the sub questions as in the previous example depicted by FIG. 4.

Compound Q&A program 132 refines an understanding of the compound question (step 210). In the example embodiment, compound Q&A program 132 refines the understanding of the compound question by identifying additional relations between the sub trees using deep semantic relations from the syntax parse and logical parse. Specifically, compound Q&A program 132 utilizesc the logical parse to determine whether logical operators across semantically entangled terms, i.e. terms having mutual parents across subtrees, should be interpreted with hard requirements, i.e. conditions X and Y must be true, or interpreted with soft requirements, i.e. conditions X and/or Y must be true. In the example embodiment, logical operators across semantically entangled terms are interpreted as having hard requirements, i.e. where conditions X and Y must be true, while logical operators across terms which are not entangled are interpreted as having soft requirements, i.e. conditions X and/or Y must be true.

Returning again to FIG. 4 and the first example question Show the metastatic sites but not local sites and sites that aren't positive for metastasis but are concerning, compound Q&A program 132 interprets and 406 as show me metastatic sites but not local sites and/or sites that aren't positive for metastasis but are concerning because the sub questions are not semantically entangled.

Conversely, with reference to FIG. 5 and continuing the third example question Show the metastatic sites that have been present for more than 1 month and confirmed by x-ray, compound Q&A program 132 interprets and 502 as show me metastatic sites that have been present for more than 1 month and confirmed by x-ray because the sub questions are entangled. Specifically, terms site 504 and x-ray 506 are entangled, thus the logical operator and 502 is interpreted using a hard requirement on and 502.

Compound Q&A program 132 retrieves candidate answers to the sub question(s) (step 212). In the example embodiment, compound Q&A program 132 first identifies key concepts of the sub questions using domain specific NLP and the logical parse. Compound Q&A program 132 then retrieves a list of candidate answers, or attributes, from database 122 that match any of the identified key concepts of the compound question. Compound Q&A program 132 then compares the candidate answers to criteria detailed by the leaf nodes of the sub questions, or subtrees, and then to an assertion of a soft parent logical operator. Because a soft requirement logical operator is asking for a candidate answer that fits criteria of node X and/or node Y, compound Q&A program 132 is capable of answering each individual node without reference to other nodes. Restated, attributes of nodes linked by soft requirement logical operators need only fit the criteria of node X or the criteria of node Y and not both. Thus compound Q&A program 132 can identify an answer fitting node criteria X without regard to node criteria Y and vice versa. This process is then recursively performed on the logical parse tree from leaf nodes to the root node until a hard logical operator is reached, in which case the candidate must be consider in light of multiple subtrees. In the example embodiment, compound Q&A program 132 then evaluates and ranks the list of answer candidates with regard to the relevance score assigned above, when applicable. From this ranking, compound Q&A program 132 selects a best candidate answer to each subtree.

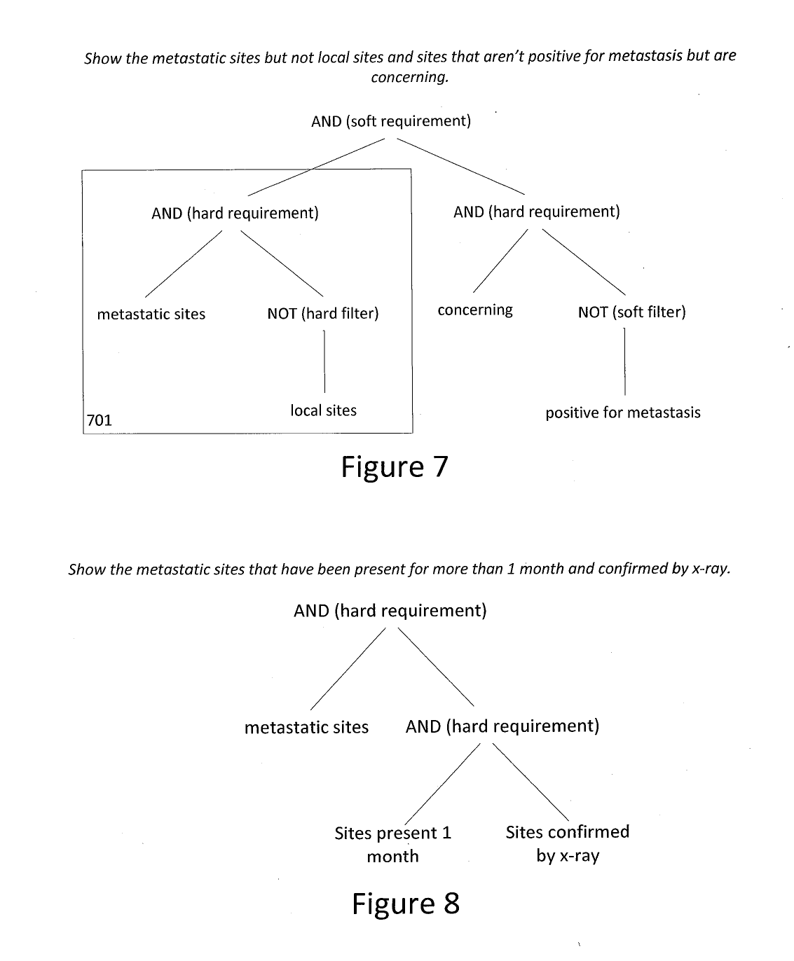

Continuing the first example question having the sub question, in part, Show the metastatic sites but not local sites, compound Q&A program 132 performs a search of database 122 to retrieve the metastatic site candidate answer There is a 7 mm lesion on the right lung from a patient's records that excludes local sites, in accordance with hard filter defined by the logical structure of the sub question (depicted by logical structure 701 of FIG. 7). Compound Q&A program 132 then ranks the sub questions candidate answers.

Compound Q&A program 132 performs a final rollup of candidate answers for the compound question (step 214). As part of the final rollup, compound Q&A program 132 evaluates candidate answers in light of the final logical structure of the compound question as a whole, including hard logical operator requirements. As previously mentioned, hard requirement logical operators require an answer that fits criteria across multiple subtrees, i.e. fits node X criteria and node Y criteria, and thus must be answered in context of the other nodes. In the example embodiment, the final rollup evaluation is performed similar to that of retrieving candidate answers, however in the final rollup hard logical operators are considered. This process is then recursively performed up the logical parse tree until the final parent logical operator is reached.

Continuing the example above with reference to the first example having the question Show the metastatic sites but not local sites and sites that aren't positive for metastasis but are concerning, compound Q&A program 132 obtains the final logical structure for the sub questions and compound question, as depicted by FIG. 7. Compound Q&A program 132 first searches the corpus for candidates based on each independent fact—metastatic sites, local sites, concerning sites, positive for metastasis. Then, for each sibling pair (metastatic sites/local sites and concerning sites/positive for metastasis), compound Q&A program 132 creates a set of candidates that is the union of those pairs. Compound Q&A program 132 then evaluates those union pairs in the context of the leaf node and the parent logical operators. In this example, only those candidates sites that are both metastatic and not local will make the cut on the left side of the tree. Finally, compound Q&A program 132 recursively evaluates the remaining candidates up the tree until the final hard and is reached. Technically, the algorithm can stop when only or's or soft and's remain, as they won't apply any additional filtering.

Compound Q&A program 132 displays the candidate answers of each sub question to the user (step 216). In the example embodiment, compound Q&A program 132 transmits the candidate answers of each sub question to computing device 110 via network 108 for display in user interface 112. Moreover, compound Q&A program 132 renders and rolls up the candidate answers of the sub question with reference to a logical hierarchy (described in more detail below). In the example embodiment, compound Q&A program 132 renders the candidate answers on an interface that lets the user see the sub questions and change the tree as necessary. For example, a user may adjust the interpretation of the question, such as changing filters, requirements, and relevance, as well as increase or reduce facts/criteria to see different candidate answers.

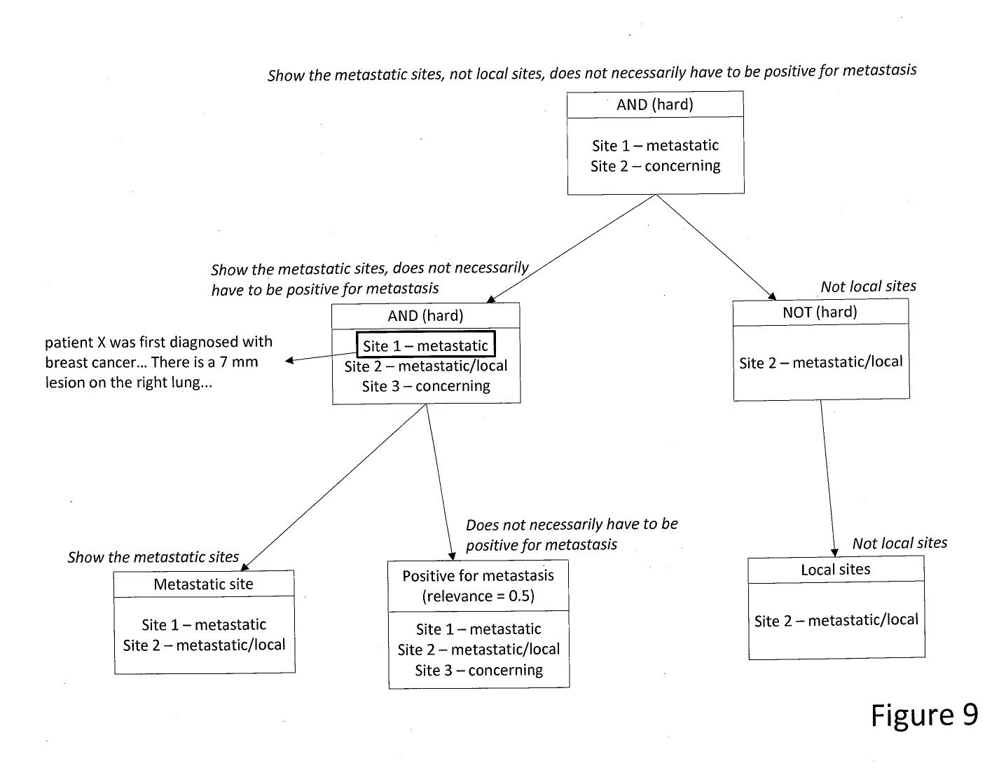

Continuing the earlier example having the fourth question Show the metastatic sites, not local sites, does not necessarily have to be positive for metastasis, the logical hierarchy of the sub questions is presented as a tree, as depicted by FIG. 9. Each leaf node in the tree shows either a logical connection between facts along with NLP modifiers (hard, relevance, etc.) and a collection of candidate answers for each node in the tree. In the patient for which the compound question pertains to, there are three sites: site 1—metastatic; site 2—local; and site 3—concerning. Every site that matches an individual fact are at the leaf nodes. On the positive for metastasis node, the concerning site is allowed because of the relevance qualifier that indicates that the fact is not firm, i.e. 0.5 as opposed to default relevance score of 1. When the answers are completed, that answer is prioritized below site 1—metastatic and site 2—local because the only node that contributed to site 3—concerning existence is a low relevance node. At the second level of the tree, all three sites as candidates are on the left side (metastatic site but not necessarily positive for metastasis) and only one on the right (not local sites). The right side of the tree acts as a hard filter, so site 2—local doesn't make the final cut when compound Q&A program 132 combines the candidate answers in the top level and. Based on this interpretation, compound Q&A program 132 determines the candidate answers for the compound question are site 1—metastatic and site 3—concerning. Accordingly, compound Q&A program 132 returns metastatic and concerning sites as answers, for example patient X was first diagnosed with breast cancer . . . There is a 7 mm lesion on the right lung . . .

FIG. 3 depicts a compound question with annotated relevance qualifiers.

FIG. 4 depicts a syntax parse of a compound question into sub questions.

FIG. 5 depicts a logical representation of a compound question.

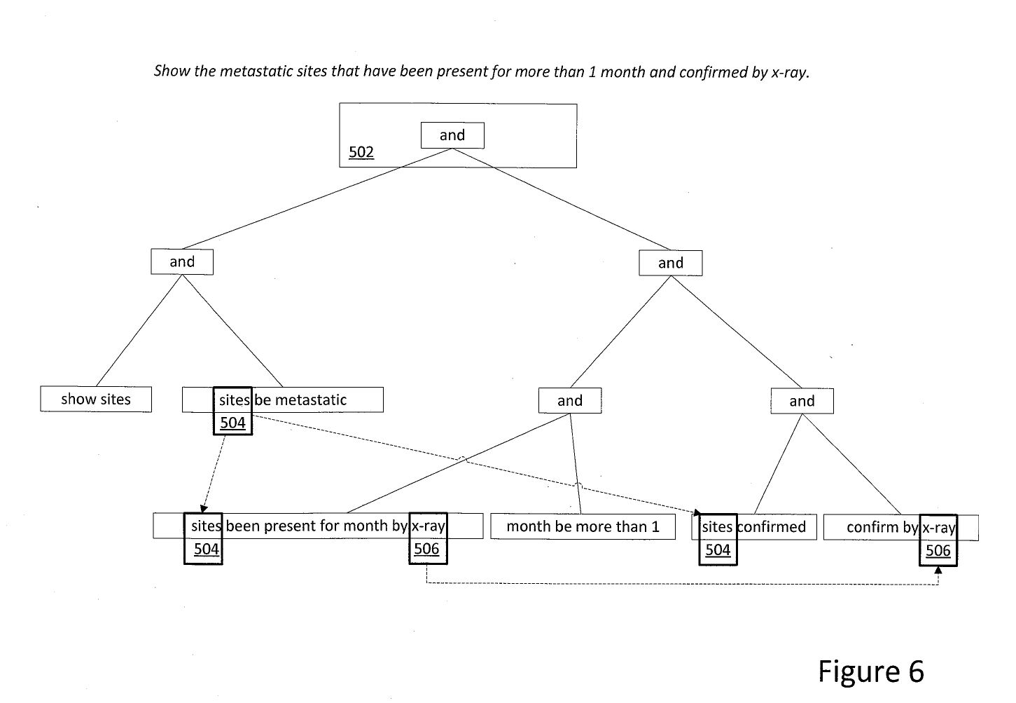

FIG. 6 depicts a visual representation of a logical parse of a compound question with semantic entanglement.

FIG. 7 depicts a full logical rollup of logical structure for a compound question.

FIG. 8 depicts a full logical rollup of a logical structure for a compound question.

FIG. 9 depicts the displaying of candidate answers.

While the present invention has been described and illustrated with reference to particular embodiments, it will be appreciated by those of ordinary skill in the art that the invention lends itself to many different variations not specifically illustrated herein.

The present invention may be a system, a method, and/or a computer program product. The computer program product may include a computer readable storage medium (or media) having computer readable program instructions thereon for causing a processor to carry out aspects of the present invention.

FIG. 10 depicts a block diagram of components of computing device 110, server 120, and server 130 of the compound Q&A system 100 of FIG. 1, in accordance with an embodiment of the present invention. It should be appreciated that FIG. 10 provides only an illustration of one implementation and does not imply any limitations with regard to the environments in which different embodiments may be implemented. Many modifications to the depicted environment may be made.

Computing device 110 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example compound Q&A program 132, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Computing device 110 may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Computing device 110 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

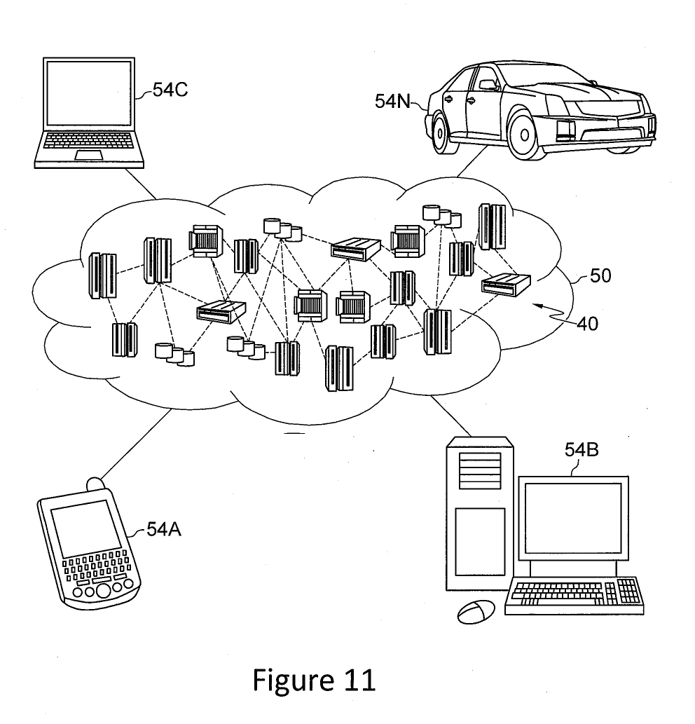

Referring now to FIG. 11, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 40 and cloud computing environment 50 can communicate with any type of computerized device over any type of network and/or network addressable connection (e.g., using a web browser).

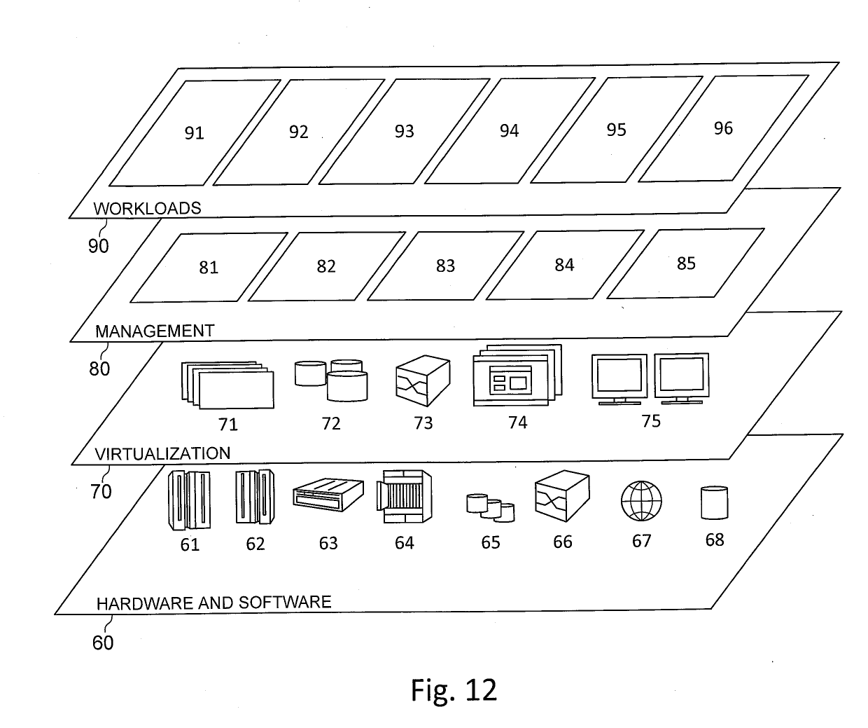

Referring now to FIG. 12, a set of functional abstraction layers provided by cloud computing environment 50 (FIG. 4) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and compound Q&A processing 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for answering compound questions, the method comprising:
a computer receiving a compound question comprising one or more sub questions;
the computer generating a logical parse of the compound question; and
the computer answering the compound question based on the logical parse.

2. The method of claim 1, wherein answering the compound question based on the logical parse further comprises:
the computer determining whether an instance of a term appears in two or more sub questions of the one or more sub questions; and
based on determining that an instance of a term appears in two or more sub questions of the one or more sub questions, the computer identifying one or more candidate answers that answer the two or more sub questions.

3. The method of claim 2, further comprising:
based on determining that an instance of a term does not appear in two or more sub questions of the one or more sub questions, the computer identifying one or more candidate answers that answer at least one of the two or more sub questions.

4. The method of claim 3, further comprising:
the computer ranking the one or more candidate answers; and
the computer displaying the ranked one or more candidate answers.

5. The method of claim 1, wherein answering the compound question is further based on the computer identifying at least one of a negated span of text, a hypothetical span of text, and a relevance qualified span of text within the compound question.

6. The method of claim 5, further comprising:
the computer determining whether the negated span of text contains a linking verb; and
based on determining that the negated span of text contains a linking verb, the computer excluding one or more candidate answers meeting a criteria within the negated span of text.

7. The method of claim 6, further comprising:
based on determining that the negated span of text does not contain a linking verb, the computer excluding one or more candidate answers detailed by the negated span of text.

8. A computer program product for answering compound questions, the computer program product comprising:
one or more computer-readable storage media and program instructions stored on the one or more computer-readable storage media, the program instructions comprising:
program instructions to receive a compound question comprising one or more sub questions;
program instructions to generate a logical parse of the compound question; and
program instructions to answer the compound question based on the logical parse.

9. The computer program product of claim 8, wherein the program instructions to answer the compound question based on the logical parse further comprises:
program instructions to determine whether an instance of a term appears in two or more sub questions of the one or more sub questions; and
based on determining that an instance of a term appears in two or more sub questions of the one or more sub questions, program instructions to identify one or more candidate answers that answer the two or more sub questions.

10. The computer program product of claim 9, further comprising:
based on determining that an instance of a term does not appear in two or more sub questions of the one or more sub questions, program instructions to identify one or more candidate answers that answer at least one of the two or more sub questions.

11. The computer program product of claim 10, further comprising:
program instructions to rank the one or more candidate answers; and
program instructions to display the ranked one or more candidate answers.

12. The computer program product of claim 8, wherein the program instructions to answer the compound question is further based on program instructions to identify at least one of a negated span of text, a hypothetical span of text, and a relevance qualified span of text within the compound question.

13. The computer program product of claim 12, further comprising:
program instructions to determine whether the negated span of text contains a linking verb; and
based on determining that the negated span of text contains a linking verb, program instructions to exclude one or more candidate answers meeting a criteria within the negated span of text.

14. The computer program product of claim 13, further comprising:
based on determining that the negated span of text does not contain a linking verb, program instructions to exclude one or more candidate answers detailed by the negated span of text.

15. A computer system for answering compound questions, the computer system comprising:
one or more computer processors, one or more computer-readable storage media, and program instructions stored on one or more of the computer-readable storage media for execution by at least one of the one or more processors, the program instructions comprising:
program instructions to receive a compound question comprising one or more sub questions;
program instructions to generate a logical parse of the compound question; and
program instructions to answer the compound question based on the logical parse.

16. The computer system of claim 15, wherein the program instructions to answer the compound question based on the logical parse further comprises:
program instructions to determine whether an instance of a term appears in two or more sub questions of the one or more sub questions; and
based on determining that an instance of a term appears in two or more sub questions of the one or more sub questions, program instructions to identify one or more candidate answers that answer the two or more sub questions.

17. The computer system of claim 16, further comprising:
based on determining that an instance of a term does not appear in two or more sub questions of the one or more sub questions, program instructions to identify one or more candidate answers that answer at least one of the two or more sub questions.

18. The computer system of claim 17, further comprising:
program instructions to rank the one or more candidate answers; and
program instructions to display the ranked one or more candidate answers.

19. The computer system of claim 15, wherein the program instructions to answer the compound question is further based on program instructions to identify at least one of a negated span of text, a hypothetical span of text, and a relevance qualified span of text within the compound question.

20. The computer system of claim 19, further comprising:
program instructions to determine whether the negated span of text contains a linking verb; and
based on determining that the negated span of text contains a linking verb, program instructions to exclude one or more candidate answers meeting a criteria within the negated span of text.
